(19) United States
(12) Patent Application Publication
(10) Pub. No.: US 2007/0034227 A1
(43) Pub. Date: Feb. 15, 2007

(54) Ultrasonic device for cleaning connectors

(75) Inventors: Leonard T. Hesch JR., Palm Bay, FL (US); Amelia C. Leichliter, Palm Bay, FL (US)

Correspondence Address: SACCO & ASSOCIATES, PA, P.O. BOX 30999, PALM BEACH GARDENS, FL, 33420-0999, US

(73) Assignee: HARRIS CORPORATION, Melbourne, FL (US)

(21) Appl. No.: 11/203,781

(22) Filed: Aug. 15, 2005

(51) Int. Cl. B08B 3/12; B08B 9/00

(52) U.S. Cl. 134/1; 134/22.1; 134/184; 134/166 R

(57) ABSTRACT

A method and apparatus for cleaning a connector. The method includes several steps including: positioning a containment structure on an exposed end of a connector, and injecting a cleaning solvent within a chamber defined by the containment structure and the exposed end. Thereafter, the interior of the chamber containing the cleaning solvent can be exposed to an energetic stimulus, such as ultrasonic acoustic energy. After the ultrasonic energy has been applied, the solvent can be removed from the chamber.

### BACKGROUND OF THE INVENTION

1. Statement of the Technical Field

The inventive arrangements concern cleaning devices, and more particularly devices that are useful for cleaning electronic, optical, and electro-optical connectors.

2. Description of the Related Art

Military and commercial applications increasingly rely upon a wide variety of electronic, RF, optical and electro-optical connectors for communicating signals within systems and across platforms. In general, such connectors consist of an interlocking structure that permits the coupling of electrical conductors, optical fibers or a combination of the two.

It is important that connectors do not attenuate the electrical, RF and optical signals they are intended to carry. The attenuation potentially introduced by a connector can be a serious issue, particularly at microwave RF frequencies and in the optical fiber field. Connector coupling loss can result from a number of mechanisms. For example, in the fiber optic area, poor fiber alignment and improper end preparation are known to increase insertion loss. However, dust, dirt, moisture, grease, and any of a wide variety of other contaminants, can also have a significant impact on signal attenuation with regard to both RF and optical signals. Accordingly, clean connectors are highly desirable. Still, connectors can and do become contaminated with materials that are known to degrade performance. This problem is particularly true with equipment that has been deployed in harsh environments.

Before being assembled onto a cable, connectors can be cleaned by immersing the entire connector into an ultrasonic bath for successful removal of contaminants. However, once a piece of equipment is assembled, cleaning the connector becomes more difficult. In a repair shop, it is often impractical to disassemble equipment to clean a connector or contact. Cleaning equipment in the field becomes an even more difficult problem. The conventional solution to this problem is to manually clean connectors with a small brush or cotton swabs and a suitable solvent, such as alcohol. However, these methods are cumbersome and time consuming. The effectiveness of the cleaning process must also be confirmed visually. For fiber optic connectors, special optical equipment may be needed for this purpose. If the cleaning was ineffective, the steps must be repeated.

### SUMMARY OF THE INVENTION

The invention concerns a method for cleaning a connector. The method can begin by positioning a containment structure on an exposed end of a connector. For example, the connector can be a fiber-optic connector, an RF connector, an electrical connector, or an electro-optical connector. After the containment structure has been positioned on the connector, a cleaning solvent can be injected within a chamber defined by the containment structure and the exposed end. The cleaning solvent can be any of a variety of known solvents may be heated. Thereafter, interior of the chamber containing the cleaning solvent can be exposed to an energetic stimulus, such as ultrasonic acoustic energy. According to one aspect of the invention, a continuous flow of the cleaning solvent can be passed into and out of the chamber during a period of time when the energetic stimulus is applied. Alternatively, a fixed amount of cleaning solvent can be injected into the chamber and can remain there during a period of time when the energetic stimulus is applied. Thereafter, the solvent can be removed from the chamber.

According to one aspect of the method, a containment structure can be chosen that has a port which is sized and shaped for mating with the exposed end of the connector. Further, a seal can be formed at an interface of the connector and the containment structure to contain the solvent. Accordingly, a fluid cleaning solvent can be prevented from escaping from the chamber at the interface.

According to another aspect of the invention, the ultrasonic acoustic energy can have one or more enhanced cleaning characteristics. For example the frequency of the ultrasonic acoustic energy can be swept, the energy can be pulsed, and/or can have significant harmonic content.

According to an alternative embodiment, the method for cleaning a connector can include positioning within a containment structure at least a portion of a connector. A seal can then be formed at an interface of the containment structure with the connector. Thereafter, a cleaning solvent can be injected within a chamber at least partially defined by the containment structure and the connector. Any suitable cleaning solvent can be used for this purpose. For example, the solvent can be an aqueous solution, a chlorinated solvent, a fluorinated solvent, or isopropyl alcohol. Finally, the interior of the chamber can be exposed to ultrasonic energy with the cleaning solvent present.

In some instances, it can be desirable to position the entire connector within the containment structure. In that case, the method can also include positioning within a containment structure at least a portion of a connector. However, rather than forming a seal at an interface of the containment structure with the connector, a seal can be formed at an interface of the containment structure with a portion of a signal cable attached to the connector. Thereafter, a cleaning solvent can be injected within a chamber at least partially defined by the containment structure and the interior of the chamber can be exposed to ultrasonic acoustic energy as described above.

The invention can also include an apparatus for cleaning a connector. The apparatus can include a containment structure having a port that is sized and shaped for receiving therein an exposed end of a connector. The apparatus can also include a sealing structure provided at the port to form a fluid seal at an interface of the port and the connector. At least one fluid conduit can be provided in fluid communication with a chamber that is at least partially defined by the containment structure. Further an ultrasonic transducer can be positioned at a location for communicating ultrasonic acoustic energy to the interior of the chamber. The apparatus can be used to implement the methods described herein for cleaning a connector.

According to yet another embodiment, the apparatus according to the invention can include a containment structure sized and shaped for receiving at least a portion of a connector. The containment structure can have a sealing structure that is adapted for defining a fluid seal at an interface of the containment structure with at least a portion of the connector or a with a signal cable attached to the connector. As with the previously described embodiments, at least one fluid conduit is provided in fluid communication with a chamber that is at least defined by the containment structure. Likewise, an ultrasonic transducer is provided at a location chosen for communicating ultrasonic acoustic energy to the interior of the chamber.

With each of the apparatus herein described, a fluid control system can be provided that selectively controls an injection of a cleaning solvent through the fluid conduit and into the chamber. A second fluid conduit can be provided for removing the cleaning solvent from the chamber.

### BRIEF DESCRIPTION OF THE DRAWINGS

FIG. 1 is a flow chart that is useful for understanding the invention

FIG. 2 is perspective view of an embodiment of the invention.

FIG. 3 is a cross-sectional view of an apparatus for cleaning a connector taken along line 3-3.

FIG. 4 is a cross-sectional view of the apparatus in FIG. 2 shown being placed onto an exposed end of a connector.

FIG. 5 is a cross-sectional view of the apparatus in FIG. 2 shown positioned on the exposed end of a connector.

FIG. 6 is a cross-sectional view of an alternative embodiment of the apparatus for cleaning a connector, shown being placed onto an exposed end of a connector.

FIG. 7 is a cross-sectional view of the apparatus in FIG. 5 shown positioned on the exposed end of a connector.

FIG. 8 is a cross-sectional view of the apparatus in FIGS. 6 and 7, with a removable adaptor added.

FIG. 9 is a block diagram that is useful for understanding the apparatus for cleaning a connector.

### DETAILED DESCRIPTION OF THE PREFERRED EMBODIMENTS

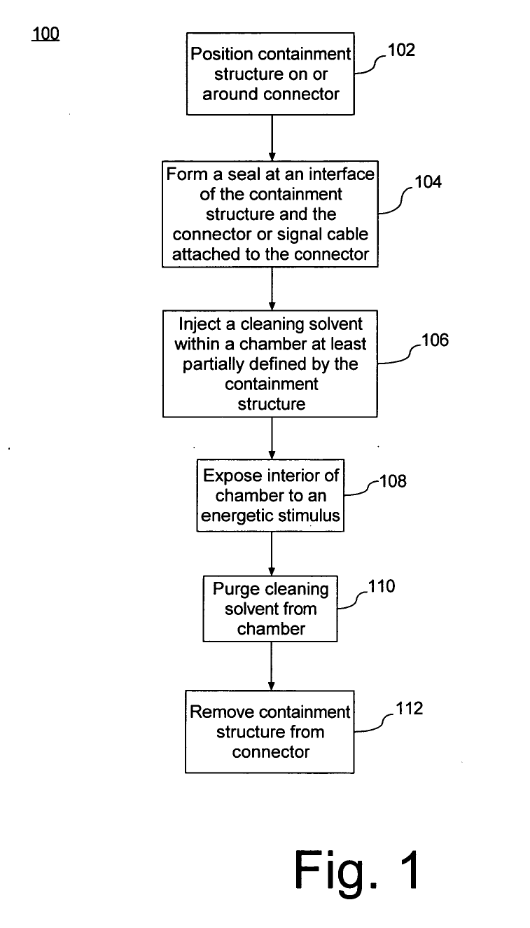

A method for cleaning a connector shall now be described in relation to flowchart 100 which is shown in FIG. 1. The method can begin in step 102 by positioning a containment structure on or around a portion of a connector. The connector can be, without limitation, a fiber-optic connector, an RF connector, an electrical connector, or an electro-optical connector.

The containment structure can have a variety of different designs that are suited for receiving the connector in step 102. However the containment structure should be arranged so that at least that portion of the connector that requires cleaning is received within the containment structure in step 102. For example, the containment structure can be configured to receive an exposed end of a connector, the entire connector, or any other portion of the connector. Regardless of the selected portion of the connector that is received in the containment structure in step 102, the containment structure can form at least a portion of an enclosed chamber that surrounds part or all of the connector.

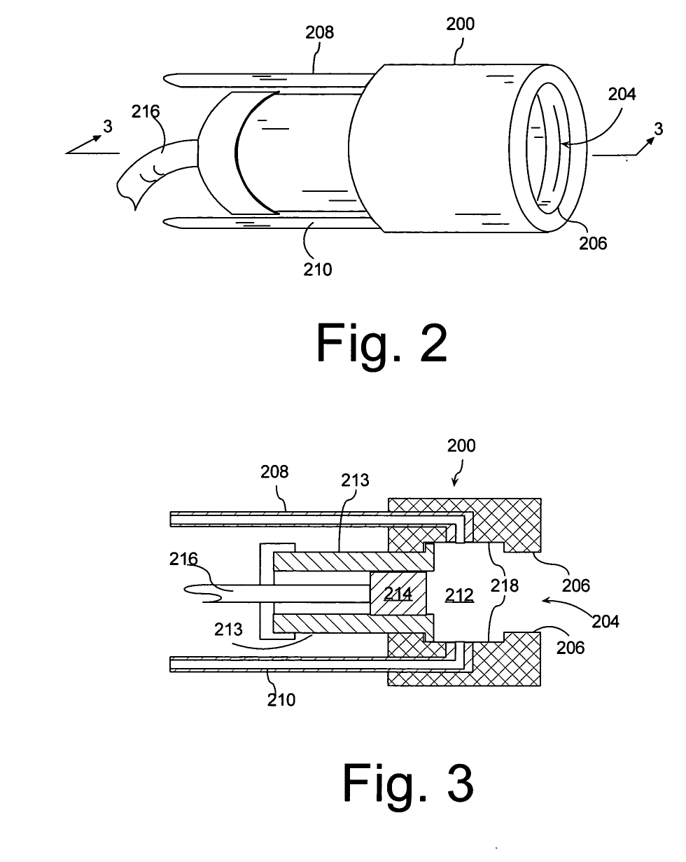

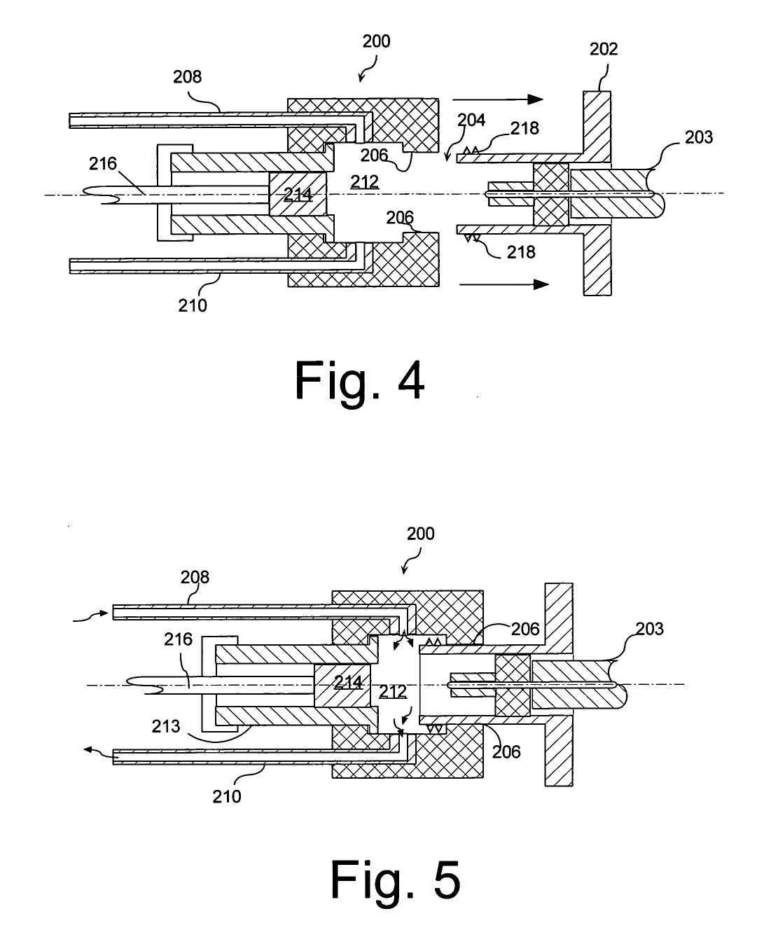

One example of containment structure 200 that can be used in accordance with the inventive arrangements is illustrated in FIGS. 2-3. In FIGS. 4 and 5, the containment structure is shown being positioned on an exposed end of a connector 202 in accordance with step 102.

In step 104, a seal can be formed at an interface of the containment structure 200 and the connector 202. The seal thus formed can substantially prevent any fluid subsequently introduced within chamber 212 from escaping. FIG. 5 shows containment structure 200 being placed on an exposed end of connector 203 to form a seal as described in step 104. However, it should be appreciated that the invention is not limited in this regard. As an alternative to the arrangement shown in FIGS. 4 and 5, the entire connector 202 could be received within a containment structure that is somewhat larger than the one shown. In that case, the containment structure 200 could be designed to form a seal around a portion of an attached signal cable 203 that communicates signals to and from the connector. Accordingly, it should be understood that the seal described herein can be formed around a periphery of any portion of the connector 202, around a periphery of the signal cable 203 attached to the connector, or any combination thereof.

In step 106, a cleaning solvent can be injected within the chamber defined by the containment structure. For example, in FIGS. 2-5, one or more fluid conduits 208, 210 can be provided for this purpose. The fluid conduits 208, 210 allow fluid to be added and removed from the chamber 212. The cleaning solvent used in step 106 can be any of a variety of known industrial solvents. For example, the solvent can include an aqueous solution, a chlorinated solvent or a fluorinated solvent. Alternatively, industrial grade isopropyl alcohol is a well known solvent that can also be used for this purpose. However, it should be noted that the invention is not limited with regard to the particular type of solvent that is used. Instead, the precise selection of the solvent will depend on the material of the connector, the nature of the contaminant to be cleaned, economic and environmental concerns. The method described herein is intended to include the use of any solvents know now or in the future that are suitable for cleaning.

There are several different techniques that can be used to introduce the cleaning solvent within the chamber. According to one aspect of the invention, a continuous flow of the cleaning solvent can be passed into and out of the chamber during a cleaning period. Alternatively, a fixed amount of cleaning solvent can be injected into the chamber and can remain there during the cleaning period. For example, according to one embodiment of the invention, the chamber can be entirely filled with solvent during all or part of the cleaning process. Still, the invention is not limited in this regard, and in some instances it may be desirable to only partially fill the chamber with solvent.

Once the cleaning solvent has been introduced into the chamber in step 106, the cleaning process can continue. In step 108 an interior of the chamber containing the solvent can be exposed to an energetic stimulus. For example, ultrasonic acoustic energy can advantageously be used for this purpose. In order to more fully understand this process, reference is made to FIGS. 2-5 which show an ultrasonic transducer 214 positioned adjacent to chamber 212. The ultrasonic transducer can apply ultrasonic energy to the interior of the chamber 212.

The ultrasonic acoustic energy applied in step 108 can be any frequency range and power level suited for cleaning connectors. Such frequencies and power levels are well known among those skilled in the art. For example, ultrasonic acoustic energy applied to the connector can have a frequency selected to be in the range of between about 10 kHz and 10 MHz, depending upon the particular cleaning application. The most commonly used frequencies for industrial cleaning are those between 20 kHz and 50 kHz. However, frequencies above 50 kHz are more commonly used for high precision cleaning and removal of small particles. Accordingly, such frequencies can in some instance be more suitable for cleaning delicate connectors.

The ultrasonic acoustic energy in step 108 can also have one or more enhanced cleaning characteristics. For example the frequency of the ultrasonic acoustic energy can be swept, the energy can be pulsed, and/or can have significant harmonic content.

Power levels of the ultrasonic acoustic energy can be selected as appropriate for the relatively small size of the cleaning chamber. Too much ultrasonic power is known to result in cavitation erosion occurring on delicate or highly polished parts that are near the transducer radiating surface. In this regard, certain relatively soft materials such as aluminum, copper and brass can be especially susceptible to cavitation erosion. Accordingly, it can be desirable to maintain the power level of the applied acoustic energy to a relatively low level. Ultrasonic cleaning power levels are generally expressed as watts per gallon. Typical power levels for ultrasonic cleaning range from about 2 watts per gallon to about 200 watts per gallon, depending on the application. However, the invention is not limited to any particular range of power level.

In step 110, the solvent can be removed or purged from the chamber. The invention is not limited to any particular method of purging the chamber, provided however that the purging process should be chosen to avoid the re-introduction of contaminants into the chamber and onto the connector. According to one aspect of the invention, a gas can be used to purge the chamber. The gas selected for this purpose can be introduced to the chamber under pressure to drive out the cleaning solvent. Inert gases are preferred for this purging process, but the invention is not limited in this regard. Once the solvent is purged from the chamber, the containment structure can be removed from the connector in step 112 and the connector can be returned to service.

Those skilled in the art will appreciate that the cleaning process can also include other steps. For example, a degassing step can be included to remove any dissolved gas from the cleaning solvent prior to cleaning. It may also be desirable in some instances to include a rinsing step during which a rinsing agent is injected into the chamber after the solvent has been purged and before the connector is removed from the containment structure. These and other conventional ultrasonic cleaning steps are well known in the art.

The details of the containment structure 200 will now be discussed in further detail in relation to FIGS. 2-5. Referring to FIG. 2-5, it can be observed that the containment structure 200 can have a generally cylindrical form that is sized and shaped for mating with connector 202. The containment structure 200 can include a port 204 that is sized and shaped for receiving therein an exposed end of a connector 202. Those skilled in the art will readily appreciate that a wide variety of connector sizes, shapes and configurations are available for electronic, RF, fiber-optic, and electro-optical connectors. Accordingly, the exact size, shape and configuration of the containment structure and the port will depend on the connector it is designed to clean.

As shown in FIGS. 3-5, the containment structure 200 advantageously defines a cleaning chamber 212. The chamber 212 is partially enclosed by the walls 218 of the containment structure. Fluid conduits 208, 210 can be provided in fluid communication with the chamber 212. According to one embodiment, fluid conduit 208 can be used to inject solvent into the chamber 212, and fluid conduit 210 can be used to drain solvent from the chamber. One or more fluid control valves, pumps and/or pressurized gas can be provided for controlling the flow of solvent into and out of the chamber 212.

Ultrasonic transducer 214 can be positioned within a housing 213 associated with containment structure 200. The transducer can be located within or adjacent to the containment structure 202 for communicating ultrasonic acoustic energy to the interior of the chamber 212. The exact location of the transducer is not critical provided that it is suitable for injecting ultrasonic acoustic energy into the chamber 212. Transducer 214 can be selected to be any of a variety of well known devices for producing ultrasonic acoustic energy. For example, magnetostrictive or piezoelectric type transducers can be used for this purpose. Still, piezoelectric transducers are known to be somewhat less massive. This allows piezoelectric transducers to respond to more rapid frequency changes as compared to a magnetostrictive transducer. Consequently, piezoelectric transducers can be more well suited for producing specialized ultrasound waveforms that are useful for cleaning. Power for operating the ultrasonic transducer can be provided via a power cable 216.

In the example containment structure shown in FIGS. 2 and 3, a sealing structure 206 can be provided at the periphery of the port 204. The sealing structure can be advantageously configured for forming a fluid seal at an interface of the port 204 and any connector to be cleaned. For example, in FIGS. 2-5, a seal 206 can be formed from a resilient rubber material for providing a snug liquid-tight seal around a periphery of the connector 202. Alternatively, the seal 206 could be designed so that it interlocks with a threaded end portion 218 of the connector 202. Those skilled in the art will appreciate that invention is not limited to any particular type of sealing structure. Accordingly, a friction fitting, resilient rubber seal, threaded fitting, snap fit, or any other arrangement can be used for the sealing structure. Regardless of the precise arrangement selected, the sealing structure should be configured for creating a liquid seal at the interface with the connector. Alternatively, if the entire connector body is received within the chamber 212, then the sealing structure can be designed to form a seal about a periphery of a signal cable 203 that is attached to the connector.

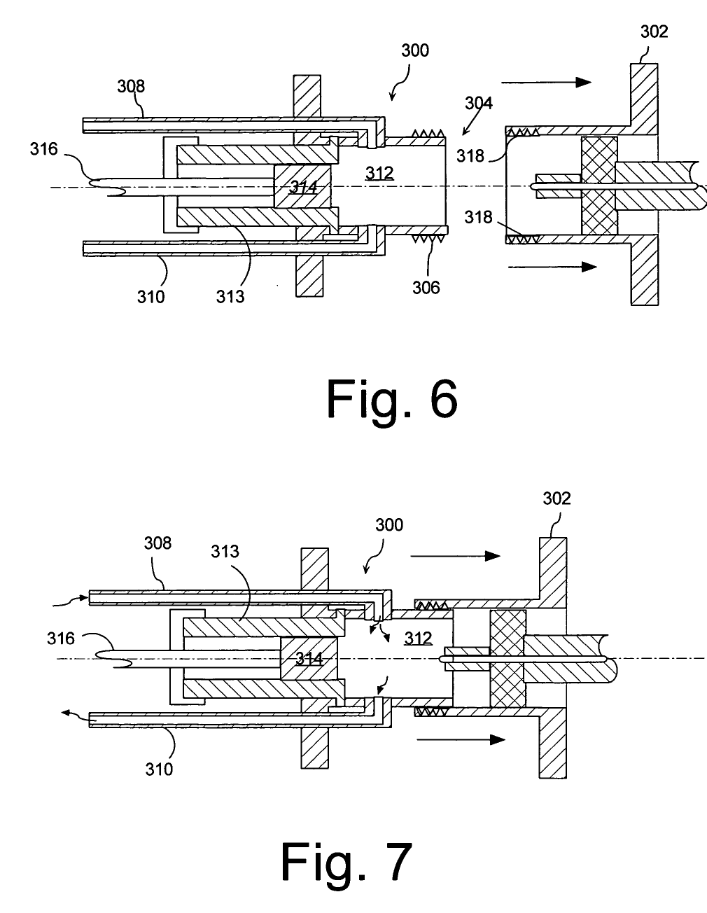

Referring now to FIGS. 6 and 7, there is shown a somewhat different example of a containment structure for an oppositely sexed connector as compared to that shown in FIGS. 2-5. In FIGS. 6 and 7, the containment structure 300 includes a chamber 312 with port 304, sealing structure 306, fluid conduits 308, 310, and power cable 316. Notably, the sealing structure 306 in this instance is a threaded arrangement designed to engage connector threads 318.

In yet another embodiment of the invention shown in FIG. 8, the sealing structure 300 can be designed for receiving a plurality of interchangeable adaptors such as adaptor 800. The various interchangeable adaptors can be removably attached to the sealing structure 306 or other convenient part of the containment structure. Each of the adaptors can at least partially modify the containment structure 300 so that is has a port, sealing structure, or chamber that more closely corresponds to the structure of a particular connector type which is to be cleaned. For example, the adaptor can allow the containment structure to form a mating connection with the connector. In this way, a single containment structure 300 can be used to clean a wide variety of different types of connectors, limited only by the number of different adaptors.

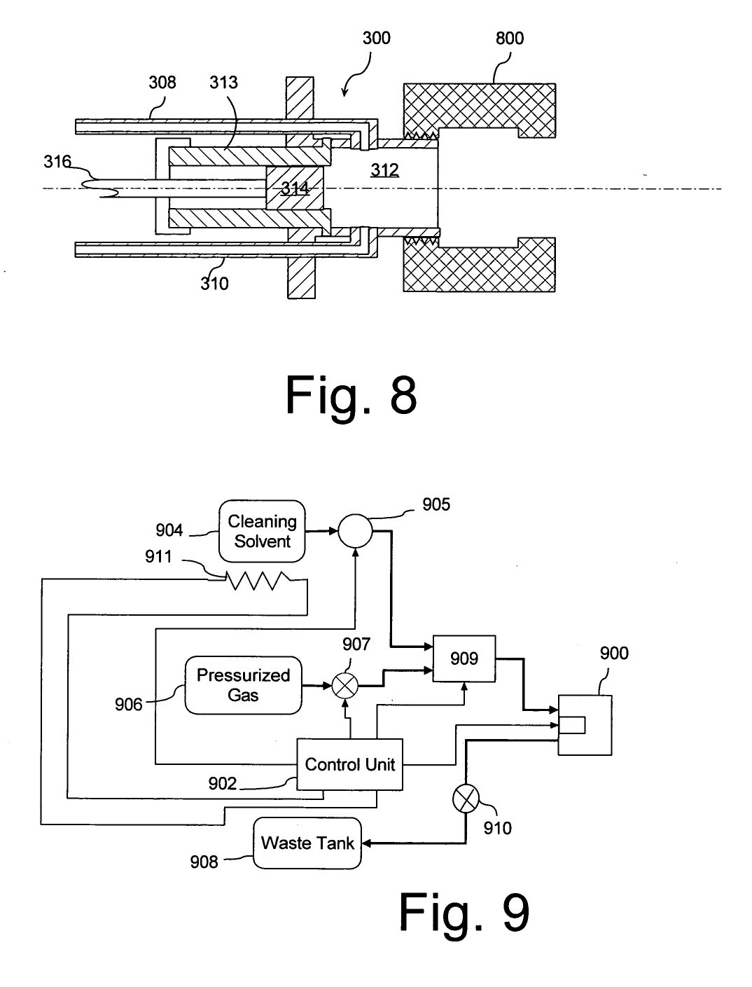

Turning now to FIG. 9, there is shown a block diagram of a connector cleaning system that is useful for understanding the operation of the present invention. The cleaning system can include a containment structure 900 having features similar to those previously described in relation to FIGS. 2-8. The cleaning system can also include a reservoir 904 containing cleaning solvent, a heater 911 for heating the cleaning solvent, a gas chamber 906 containing a pressurized gas, and a waste tank 908. A fluid control system can be provided for controlling the injection and purging of fluid from a cleaning chamber associated with the containment structure 900. The fluid control system can include a fluid pump 905, control valve 907, gated manifold 909, waste valve 910, and a control unit 902. The control unit 902 can be an essentially manual type system permitting an operator to turn on and off the pump 905, open and close valves 907 and 910, control the operation of manifold 909, as necessary to perform the cleaning process described herein. Alternatively, the control unit can include a microcontroller or microprocessor that automatically cycles the various pumps, valves, manifold gates and so on, in order to perform the cleaning process after the containment structure has been positioned.

We claim:

1. A method for cleaning a connector, comprising:
positioning a containment structure on an exposed end of a connector;
injecting a cleaning solvent within a chamber defined by said containment structure and said exposed end; and
exposing the interior of said chamber to an energetic stimulus.

2. The method according to claim 1, wherein said positioning step further comprises forming a seal at an interface of said connector and said containment structure.

3. The method according to claim 1, further comprising selecting said energetic stimulus to be acoustic energy.

4. The method according to claim 3, further comprising selecting said energetic stimulus to be ultrasonic acoustic energy.

5. The method according to claim 4, further comprising the step of selecting said ultrasonic acoustic energy to have at least one enhanced cleaning characteristic selected from the group consisting of a swept frequency, a pulsed cleaning effectiveness of said ultrasonic acoustic energy by selecting said ultrasonic sound energy from the group consisting of a pulsed output, a swept frequency output, and a harmonic output.

6. The method according to claim 1, further comprising providing a continuous flow of said solvent into and out of said chamber during a period of time when said energetic stimulus is applied.

7. The method according to claim 1, further comprising selecting said solvent from the group consisting of an aqueous solution, a chlorinated solvent, a fluorinated solvent, and isopropyl alcohol.

8. The method according to claim 1, wherein said connector is selected from the group consisting of a fiber-optic connector, an RF connector, an electrical connector, and an electro-optical connector.

9. A method for cleaning a connector, comprising:
positioning within a containment structure at least a portion of a connector;
forming a seal at an interface of said containment structure with said connector;
injecting a cleaning solvent within a chamber at least partially defined by said containment structure and said connector; and
exposing the interior of said chamber to ultrasonic energy.

10. A method for cleaning a connector, comprising:
positioning within a containment structure at least a portion of a connector;
forming a seal at an interface of said containment structure with a portion of a signal cable attached to said connector;
injecting a cleaning solvent within a chamber at least partially defined by said containment structure; and
exposing the interior of said chamber to ultrasonic acoustic energy.

11. Apparatus for cleaning a connector, comprising
a containment structure having a port that is sized and shaped for receiving therein an exposed end of a connector;
at least one fluid conduit in fluid communication with a chamber at least partially defined by said containment structure; and
an ultrasonic transducer positioned at a location for communicating ultrasonic acoustic energy to the interior of said chamber.

12. The apparatus according to claim 11, further comprising a fluid control system for selectively controlling an injection of a cleaning solvent through said fluid conduit and into said chamber.

13. The apparatus according to claim 11, further comprising a sealing-structure provided at said port to form a fluid seal at an interface of said port and said connector.

14. Apparatus for cleaning a connector, comprising
a containment structure sized and shaped for receiving at least a portion of a connector, said containment structure having a sealing structure for defining a fluid seal at an interface of said containment structure with at least a portion of said connector or a with a signal cable attached to said connector;
at least one fluid conduit in fluid communication with a chamber at least partially defined by said containment structure; and
an ultrasonic transducer positioned at a location for communicating ultrasonic acoustic energy to the interior of said chamber.

15. The apparatus according to claim 14, further comprising a fluid control system for selectively controlling an injection of a cleaning solvent through said fluid conduit and into said chamber.

16. The apparatus according to claim 14, further comprising a second fluid conduit for removing said cleaning solvent from said chamber.

17. The apparatus according to claim 14, further comprising a plurality of adaptors, each adapted for removable attachment to said containment structure, said adaptors at least partially defining a modified containment structure corresponding to a particular connector type which is to be cleaned.
